(19) United States
(12) Patent Application Publication
(10) Pub. No.: US 2015/0258566 A1
(43) Pub. Date: Sep. 17, 2015

(54) ULTRASONIC SPRAY COATING SYSTEM AND SPRAY-FORMING HEAD THEREOF

(71) Applicant: PRECISION MACHINERY RESEARCH & DEVELOPMENT CENTER, Xitun Dist. (TW)

(72) Inventors: Hao-Chiang Cho, Chiayi City (TW); Jian-Lin Wu, Chiayi City (TW); Wei-Jen Lo, Chiayi City (TW); Wang-Lin Liu, Chiayi City (TW); Hsien-Feng Liu, Chiayi City (TW)

(73) Assignee: PRECISION MACHINERY RESEARCH & DEVELOPMENT CENTER, Xitun Dist. (TW)

(21) Appl. No.: 14/209,861

(22) Filed: Mar. 13, 2014

(51) Int. Cl. B05B 17/06; B05B 7/04

(52) U.S. Cl. CPC B05B 17/0676; B05B 7/0416

(57) ABSTRACT

An ultrasonic spray coating system includes a piezoelectric transducer, a spray-forming head and a liquid supply applicator. The spray-forming head has an air-entrainment mechanism. The air-entrainment mechanism has an air-stream channel that is formed inside a main body and a bottom body of the spray-forming head for connection with a high-pressure air source, and an air vent formed in a bottom surface of the bottom body and communicates with the air-stream channel. A length of the air vent in a horizontal direction is greater than that of the air-stream channel. The liquid supply applicator has a discharge orifice, and a control component for controlling the size of the discharge orifice.

### BACKGROUND OF THE INVENTION

1. Field of the Invention

The invention relates to a spray system, more particularly to an ultrasonic spray coating system and a spray-forming head thereof.

2. Description of the Related Art

Referring to FIG. 1, and as disclosed in U.S. Pat. No. 5,409,163, a conventional ultrasonic spray coating system 1 includes a piezoelectric converter 11 which converts high-frequency electrical energy into high-frequency mechanical energy, thereby producing vibrations. The piezoelectric converter 11 has a resonant frequency. A spray-forming head 12 is coupled to the piezoelectric converter 11 and is resonant at the resonant frequency of the piezoelectric converter 11. The spray-forming head 12 has a spray-forming tip where the vibration of the piezoelectric converter 11 concentrates. A liquid supply applicator 13 has an output surface that is formed with an orifice and that is proximate to and spaced apart from the spray-forming tip. Liquid supplied by the liquid supply applicator 13 is applied to the spray-forming tip where the liquid is atomized by the vibrations, changing the liquid into mist with droplets measured in micrometers. An air-entrainment mechanism 14 provides air for enhancing fluid distribution of the spray. However, there are two disadvantages associated with this conventional ultrasonic spray coating system 1:

(A) The overall structure is complicated and bulky, thus being quite restricted regarding spatial allocation; and

(B) The liquid supply applicator 13 is a linear atomizer and the orifice is rather small in diameter, hence the range and the spraying speed of the liquid supply are limited.

### SUMMARY OF THE INVENTION

Therefore, the object of the present invention is to provide an ultrasonic spray coating system and a spray-forming head thereof that can eliminate the aforesaid drawbacks of the prior art.

According to one aspect of the present invention, there is provided an ultrasonic spray coating system including a base seat, a piezoelectric transducer, a spray-forming head and a liquid supply applicator. The piezoelectric transducer is mounted on the base seat for generating ultrasonic vibrations.

The spray-forming head has a main body, a bottom body and an air-entrainment mechanism. The main body is mounted to and below the piezoelectric transducer, and the bottom body is integrally formed with the main body and extends downwardly from the main body in a vertical direction. A length of a bottom portion of the bottom body in a first horizontal direction that is perpendicular to the vertical direction gradually decreases downwardly in the vertical direction. The bottom body has an elongated bottom surface that extends in a second horizontal direction perpendicular to the vertical direction and the first horizontal direction. The air-entrainment mechanism has an air-stream channel and an air vent. The air-stream channel is formed inside the main body and the bottom body and is adapted to be connected to a high-pressure air source. The air vent is formed in the bottom surface of the bottom body and is in spatial communication with the air-stream channel. A length of the air vent in the second horizontal direction is greater than that of the air-stream channel.

The liquid supply applicator has a bottom seat mounted on the base seat, a discharge component and a control component. The discharge component is mounted on the bottom seat and cooperates with the bottom seat to define a discharge orifice. The control component is mounted on the discharge component for controlling the size of the discharge orifice. Liquid discharged by the liquid supply applicator is atomized by the ultrasonic vibrations and guided by high pressure air supplied by the high-pressure air source and discharged via the air vent.

According to another aspect of the present invention, there is provided the spray-forming head of the aforementioned ultrasonic spray coating system.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional ultrasonic spray coating system as disclosed in U.S. Pat. No. 5,409,163;

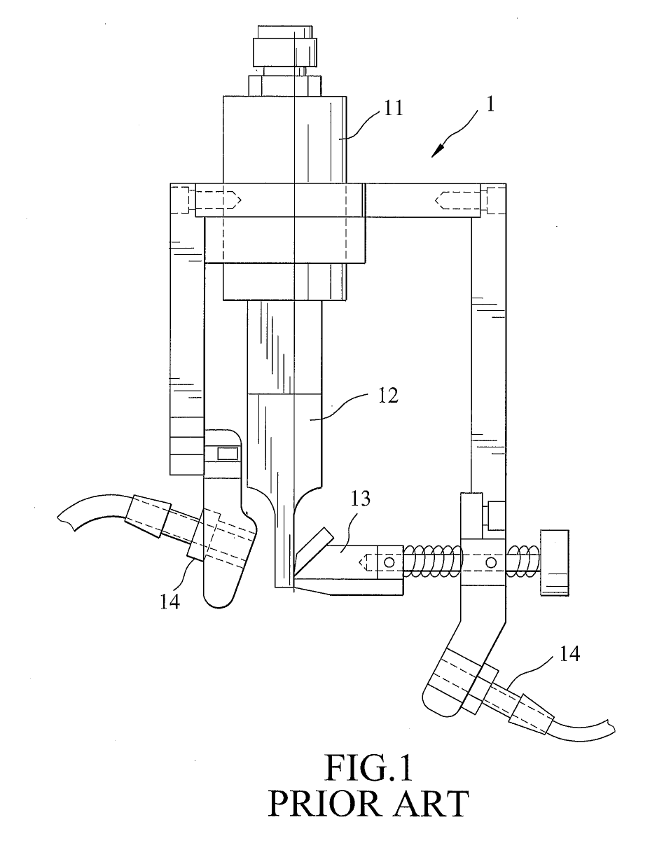

FIG. 2 is a perspective view of the first preferred embodiment of an ultrasonic spray coating system according to the present invention;

FIG. 3 is a sectional view of the first preferred embodiment;

FIG. 4 is a perspective view for illustrating a spray-forming head of the first preferred embodiment;

FIG. 5 is a sectional view of the spray-forming head;

FIG. 6 is a sectional view for illustrating a spray-forming head of the second preferred embodiment of an ultrasonic spray coating system according to the present invention;

FIG. 7 is a sectional view for illustrating a spray-forming head of the third preferred embodiment of an ultrasonic spray coating system according to the present invention; and

FIG. 8 is a sectional view for illustrating a spray-forming head of the fourth preferred embodiment of an ultrasonic spray coating system according to the present invention.

### DETAILED DESCRIPTION OF THE PREFERRED EMBODIMENTS

Before the present invention is described in greater detail, it should be noted that like elements are denoted by the same reference numerals throughout the disclosure.

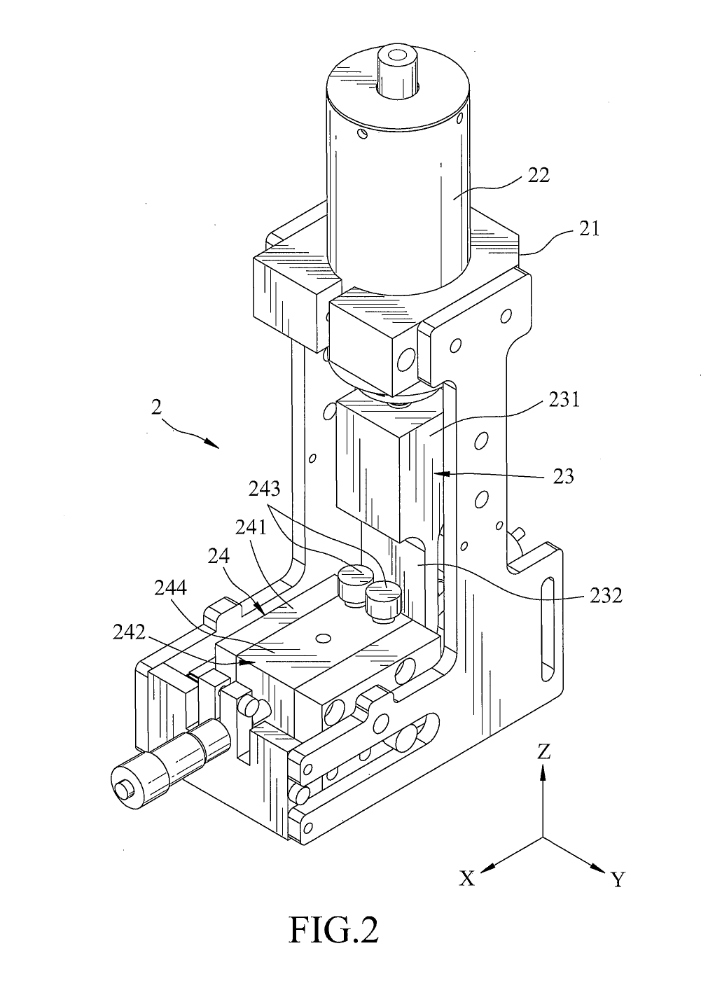

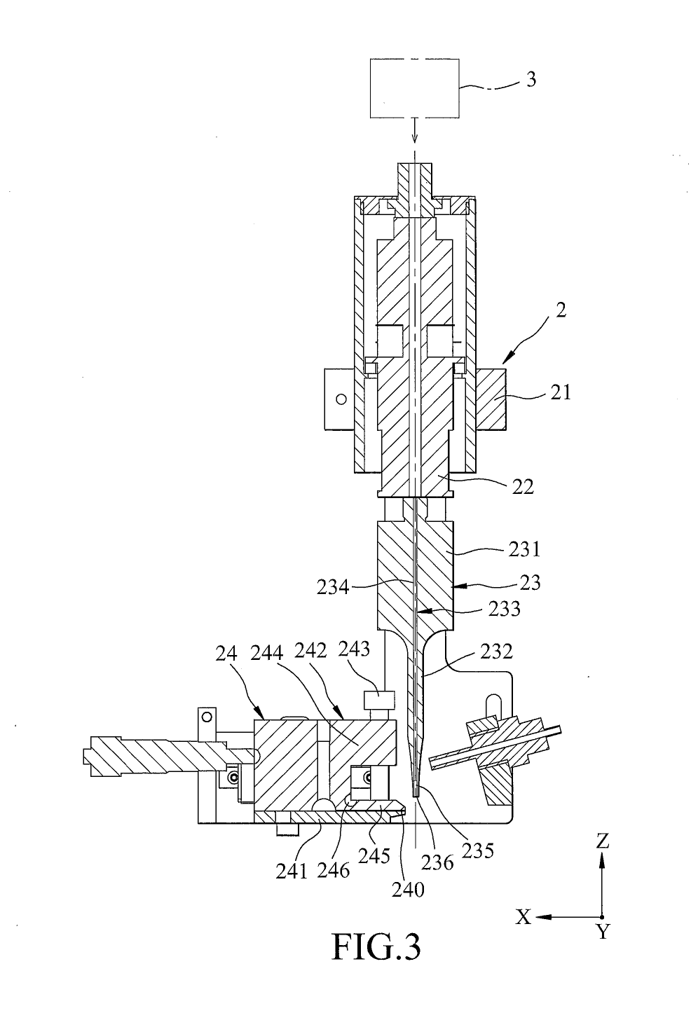

Referring to FIGS. 2 and 3, the first preferred embodiment of an ultrasonic spray coating system 2 according to the present invention includes a seat base 21, a piezoelectric transducer 22, a spray-forming head 23 and a liquid supply applicator 24. The piezoelectric transducer 22 is mounted on the base seat 21, and is made of piezoelectric material for converting high-frequency electrical energy into high-frequency mechanical energy (i.e., for generating ultrasonic vibrations).

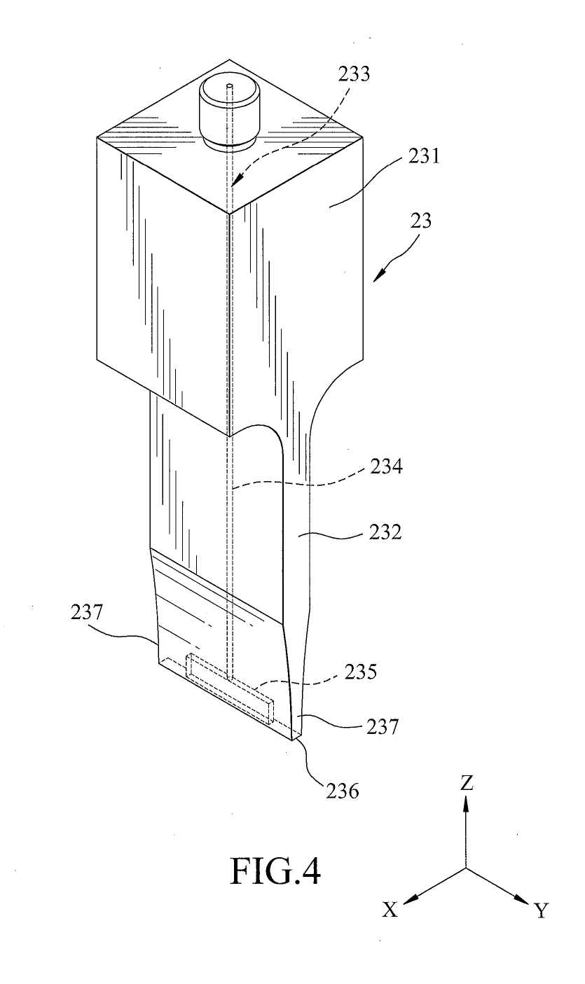

The spray-forming head 23 has a main body 231, a bottom body 232 and an air-entrainment mechanism 233. The main body 231 is mounted to and below the piezoelectric transducer 22, and the bottom body 232 is integrally formed with the main body 231 and extends downwardly from the main body 231 in a vertical direction (Z). In this embodiment, a length of a bottom portion of the bottom body 232 in a first horizontal direction (X) which is perpendicular to the vertical direction (Z) gradually decreases downwardly in the vertical direction (Z), and a length of the bottom body 232 in a second horizontal direction (Y) which is perpendicular to the vertical direction (Z) and the first horizontal direction (X) is substantially the same as that of the main body 231. The bottom body 232 has an elongated bottom surface 236 (see FIG. 4) extending in the second horizontal direction (Y), and lateral surfaces 237 opposite to each other in the second horizontal direction (Y).

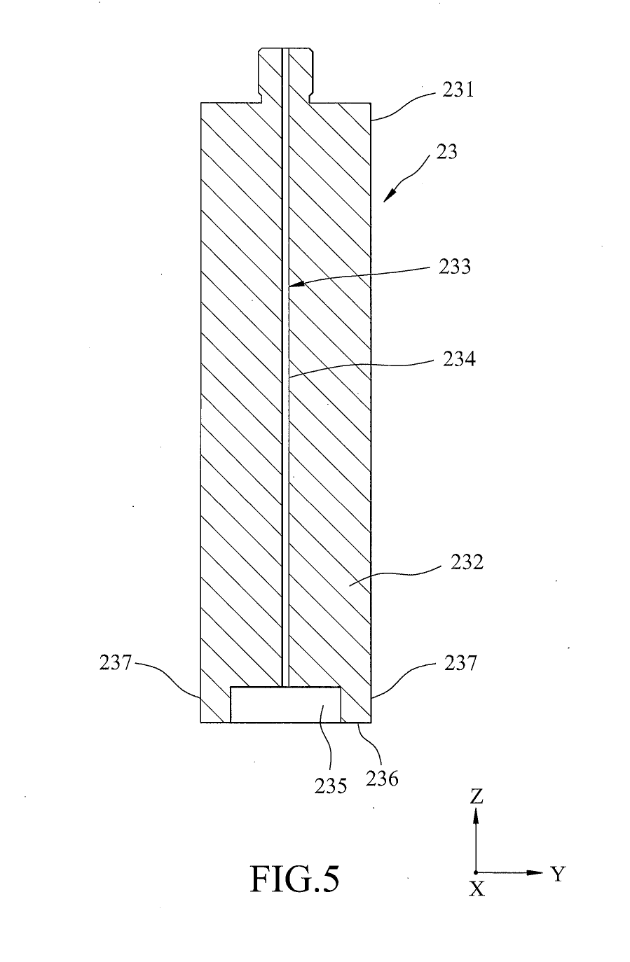

Referring to FIGS. 4 and 5, the air-entrainment mechanism 233 has an air-stream channel 234 and an air vent 235. The air-stream channel 234 is formed inside the main body 231 and the bottom body 232 and is adapted to be connected to a high-pressure air source 3 (shown in FIG. 3). The air vent 235 is formed in the bottom surface 236 of the bottom body 232 and is in spatial communication with the air-stream channel 234. A length of the air vent 235 in the second horizontal direction (Y) is smaller than that of the bottom body 232 and greater than that of the air-stream channel 234.

With further reference back to FIG. 3, the liquid supply applicator 24 has a bottom seat 241, a discharge component 242 and a control component 243. The bottom seat 241 is mounted on the base seat 21. The discharge component 242 is mounted on the bottom seat 241 and cooperates with the bottom seat 241 to define a discharge orifice 240. The control component 243 is mounted on the discharge component 242 for controlling the size of the discharge orifice 240. Liquid discharged by the liquid supply applicator 24 is atomized and guided by high-pressure air supplied by the high-pressure air source 3 and discharged via the air vent 235 of the spray-forming head 23.

The discharge component 242 of the liquid supply applicator 24 has a basic block 244, a resilient block 245 and a gap 246. The basic block 244 is mounted with the control component 243. The resilient block 245 cooperates with the bottom seat 241 to define the discharge orifice 240 having an elongated shape in the second horizontal direction (Y). The gap 246 is formed between the basic block 244 and the resilient block 245.

When the control component 243 is operated to move downward relative to the basic block 244, the resilient block 245 is moved downward by the control component 243 such that the size of the gap 246 is increased and the size of the discharge orifice 240 is decreased. On the other hand, when the control component 243 is operated to move upward (i.e., the control component 243 is released from being pressed) , the resilient block 245 can return to its original form/position thereby enlarging the size of the discharge orifice 240. Therefore, the size of the discharge orifice 240 is adjustable to control and maintain a relatively constant discharge speed in order to achieve optimal coating effect.

In this design, through the elongate design of the air vent 235 of the air-entrainment mechanism 233 in the second horizontal direction (Y) and the elongate design of the discharge orifice 240 of the liquid supply applicator 24 also in the second horizontal direction (Y), the spraying range and speed can be increased.

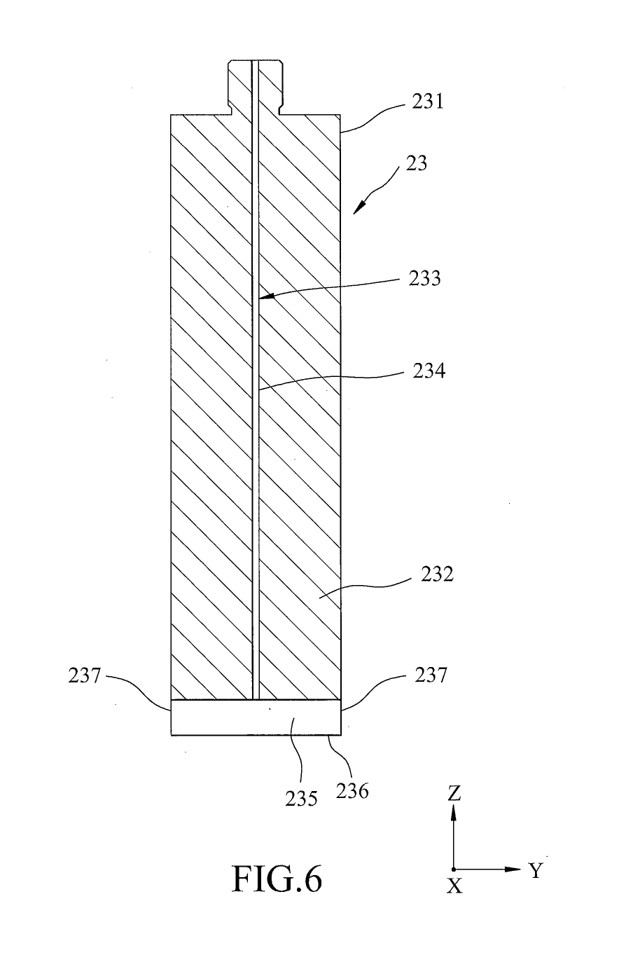

Referring to FIGS. 2 and 6, the second preferred embodiment of an ultrasonic spray coating system 2 according to the present invention is generally identical to the first preferred embodiment in structure except that the length of the air vent 235 of the air-entrainment mechanism 233 in the second horizontal direction (Y) is equal to that of the bottom body 232 of the spray-forming head 23. In other words, the air vent 235 extends through the opposite lateral surfaces 237 of the bottom body 232.

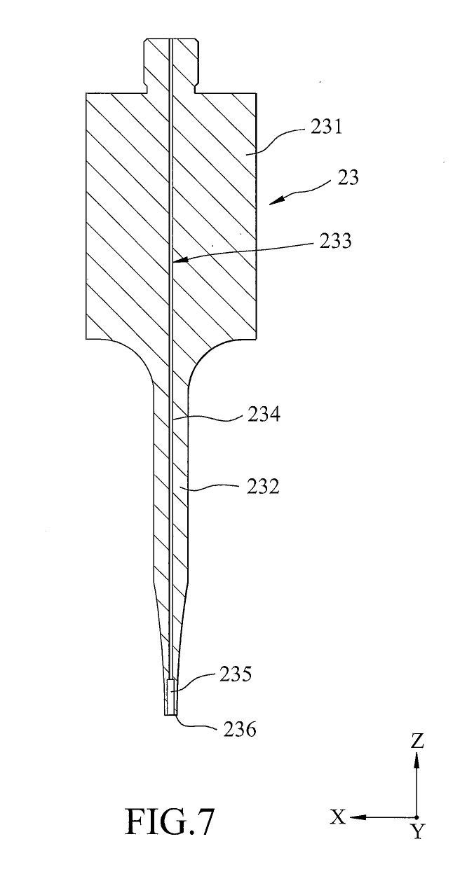

Referring to FIGS. 2 and 7, the third preferred embodiment of an ultrasonic spray coating system 2 according to the present invention is generally identical to the first preferred embodiment except that a length of the air vent 235 of the air-entrainment mechanism 233 in the first horizontal direction (X) is greater than that of the air-stream channel 234.

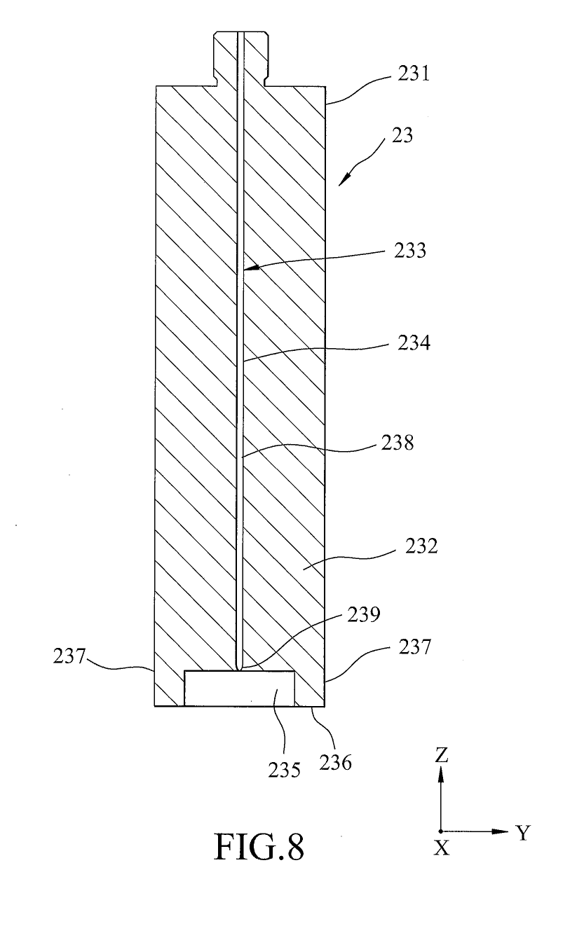

Referring to FIGS. 2 and 8, the fourth preferred embodiment of an ultrasonic spray coating system 2 according to the present invention is generally identical to the first preferred embodiment and differs in that the air-stream channel 234 of the air-entrainment mechanism 233 has a straight section 238, and a neck section 239 that is connected to the straight section 238 and the air vent 235, where the diameter of the neck section 239 is smaller than that of the straight section 238.

In summary, the advantages of the present invention are as follows.

A) The air-entrainment mechanism 233 is an integral part of the spray-forming head 23, which simplifies significantly the structural design in addition to being more flexible in spatial allocation. Moreover, the spray-forming head 23 itself is able to control the shape and direction of atomization.

B) The liquid supply applicator 24 has an elongated orifice to enable wide-range atomization so that the spraying speed is increased.

C) This invention increases the uniformity of fluid distribution of the spray. Moreover, the air stream coming through the air-entrainment mechanism 233 controls the shape and direction of atomization so that the liquid droplets of the spray coat evenly on the surface of a targeted object and will not bounce off due to excessive pressure. Therefore, the liquid is effectively consumed and the targeted object is not over-coated.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An ultrasonic spray coating system comprising:
a base seat;
a piezoelectric transducer mounted on said base seat for generating ultrasonic vibrations;
a spray-forming head having
a main body that is mounted to and below said piezoelectric transducer,
a bottom body that is integrally formed with said main body and that extends downwardly from said main body in a vertical direction, a length of a bottom portion of said bottom body in a first horizontal direction that is perpendicular to the vertical direction gradually decreasing downwardly in the vertical direction, said bottom body having an elongated bottom surface that extends in a second horizontal direction perpendicular to the vertical direction and the first horizontal direction, and
an air-entrainment mechanism that has
an air-stream channel formed inside said main body and said bottom body and adapted to be connected to a high-pressure air source, and
an air vent formed in said bottom surface of said bottom body and in spatial communication with said air-stream channel, a length of said air vent in the second horizontal direction being greater than that of said air-stream channel; and
a liquid supply applicator having
a bottom seat that is mounted on said base seat,
a discharge component that is mounted on said bottom seat and that cooperates with said bottom seat to define a discharge orifice, and
a control component that is mounted on said discharge component for controlling the size of said discharge orifice;
wherein liquid discharged by said liquid supply applicator is atomized by the ultrasonic vibrations and guided by high pressure air supplied by the high-pressure air source and discharged via said air vent.

2. The ultrasonic spray coating system as claimed in claim 1, wherein a length of said bottom body of said spray-forming head in the second horizontal direction is substantially the same as that of said main body.

3. The ultrasonic spray coating system as claimed in claim 1, wherein the length of said air vent of said air-entrainment mechanism in the second horizontal direction is smaller than that of said bottom body of said spray-forming head.

4. The ultrasonic spray coating system as claimed in claim 1, wherein the length of said air vent of said air-entrainment mechanism in the second horizontal direction is equal to that of said bottom body of said spray-forming head.

5. The ultrasonic spray coating system as claimed in claim 1, wherein a length of said air vent of said air-entrainment mechanism in the first horizontal direction is greater than that of said air-stream channel.

6. The ultrasonic spray coating system as claimed in claim 1, wherein said air-stream channel of said air-entrainment mechanism has a straight section and a neck section that is connected to said straight section and said air vent, a diameter of said neck section being smaller than that of said straight section.

7. The ultrasonic spray coating system as claimed in claim 1, wherein said discharge component of said liquid supply applicator has
a basic block mounted with said control component,
a resilient block cooperating with said bottom seat to define said discharge orifice, and
a gap formed between said basic block and said resilient block,
said control component being operable to move downward relative to said basic block so as to move said resilient block downward, thereby reducing the size of said discharge orifice.

8. The ultrasonic spray coating system as claimed in claim 1, wherein said discharge orifice is elongated in the second horizontal direction.

9. A spray-forming head adapted for an ultrasonic spray coating system, said spray-forming head comprising:
a main body;
a bottom body integrally formed with said main body and extending downwardly from said main body in a vertical direction, a length of a bottom portion of said bottom body in a first horizontal direction that is perpendicular to the vertical direction gradually decreasing downwardly in the vertical direction, said bottom body having an elongated bottom surface that extends in a second horizontal direction perpendicular to the vertical direction and the first horizontal direction; and
an air-entrainment mechanism having
an air-stream channel that is formed inside said main body and said bottom body and that is adapted to be connected to a high-pressure air source, and
an air vent that is formed in said bottom surface of said bottom body and that is in spatial communication with said air-stream channel, a length of said air vent in the second horizontal direction being greater than that of said air-stream channel.

10. The spray-forming head as claimed in claim 9, wherein a length of said bottom body of said spray-forming head in the second horizontal direction is substantially the same as that of said main body.

11. The spray-forming head as claimed in claim 9, wherein the length of said air vent of said air-entrainment mechanism in the second horizontal direction is smaller than that of said bottom body of said spray-forming head.

12. The spray-forming head as claimed in claim 9, wherein the length of said air vent of said air-entrainment mechanism in the second horizontal direction is equal to that of said bottom body.

13. The spray-forming head as claimed in claim 9, wherein a length of said air vent of said air-entrainment mechanism in the first horizontal direction is greater than that of said air-stream channel.

14. The spray-forming head as claimed in claim 9, wherein said air-stream channel of said air-entrainment mechanism has a straight section and a neck section that is connected to said straight section and said air vent, a diameter of said neck section being smaller than that of said straight section.
